(19) United States
(12) Patent Application Publication
(10) Pub. No.: US 2010/0048394 A1
(43) Pub. Date: Feb. 25, 2010

(54) HEAT-SENSITIVE RECORDING MATERIAL

(75) Inventors: Michael Horn, Offenburg (DE); Uwe Brasch, Offenburg (DE)

Correspondence Address: BROOKS KUSHMAN P.C., 1000 TOWN CENTER, TWENTY-SECOND FLOOR, SOUTHFIELD, MI, 48075, US

(73) Assignee: PAPIERFABRIK AUGUST KOEHLER AG, Oberkirch (DE)

(21) Appl. No.: 12/307,802

(22) PCT Filed: Jun. 29, 2007
(86) PCT No.: PCT/EP2007/005796

§ 371 Date: Sep. 14, 2009

(30) Foreign Application Priority Data
Jul. 12, 2006 (DE) 10 2006 032 521.4

(51) Int. Cl. B41M 5/392; B41M 5/28; B41M 5/30

(52) U.S. Cl. 503/207; 503/200

(57) ABSTRACT

A description is given of a heat-sensitive recording material comprising: a sheetlike carrier; a thermoreactive layer on at least one side of the sheetlike carrier; and an interlayer, formed between the sheetlike carrier and the respective thermoreactive layer, which comprises hollow-sphere pigments embedded in a binder; and also, if appropriate, comprising top layers and/or further layers. This recording material is characterized in that the hollow-sphere pigments take the form of a composite pigment, with nanoscale pigment particles attached to the surface of an organic hollow-sphere pigment. This material can be produced inexpensively at high operating speed. The interlayers that are proposed in accordance with the invention exhibit optimum insulation capacity. They also have the effect of reducing or preventing the unwanted phenomenon of the text showing through, particularly when the thermoreactive layers are formed on both sides of the sheetlike carrier. The recording material exhibits a high optical density, runs very well in the thermal printer, in particular without depositing on or sticking to the thermal printing head in application, and the thermal print exhibits a homogeneous appearance.

The invention relates to a heat-sensitive recording material comprising a sheet-like carrier, a thermoreactive layer on at least one side of the sheet-like carrier and an interlayer which is formed between the sheet-like carrier and the respective thermoreactive layer and contains hollow-sphere pigments embedded in a binder, as well as, if appropriate, further layers and/or top layers.

A heat-sensitive recording material of the type designated above emerges from U.S. Pat. No. 6,759,366. This has a thermoreactive layer, in each case, on the top and the bottom side of the carrier substrate. The carrier substrate is preferably based on cellulose. It is thermally insulating. It is thus ensured that a symbol only appears on the printed side during thermoprinting. A primer layer that is used to improve the adhesion of the layers is preferably formed between the carrier substrate and the thermoreactive layers. Furthermore, the primer layer is to protect the thermoreactive layer from the effect of active constituents of the substrate. The primer layers are produced using an aqueous mixture containing primarily clays. The known heat-sensitive recording material may have so-called top coats, which bring about further desirable properties of the material.

The heat-sensitive recording material known from U.S. Pat. No. 6,759,366. exhibits various drawbacks; the insulating properties mentioned are thus not satisfactory. When using a thin carrier substrate with normal insulating capacity, it is necessary to form the primer layers with a high weight application as otherwise an undesired showing through of text from one side to the other would occur. If a thicker carrier substrate were to be selected, higher costs, undesired high rigidity of the material and poor abutment of the thermal print head against the substrate surface would be connected with this. In addition, difficulties may occur during the simultaneous formation of the clay-containing interlayers during the application of the respective coating slips, so the rheological properties of the coating slips have to be controlled in a targeted and costly manner. Further drawbacks are shown in that there are limitations with regard to the economical simultaneous formation of the clay-containing interlayers with regard to the selection of the application method when it is a question of achieving a high surface smoothness of the interlayers especially promoting the print properties. Finally, the maximum application speed is limited because of the rheologically problematical behaviour of the clay-containing coating slip.

The invention is therefore based on the aim of developing the recording material described above in such a way that the drawbacks mentioned are eliminated, especially, a satisfactory insulating effect at the smallest weight per unit area of the interlayers and a low weight per unit area of the sheet-like carrier as well as an adequately adsorptive fixing capacity for the materials present in the molten state is to be ensured. The interlayers should favour the opacity of the total recording material, so the appearance of the respective text through the two sides of the recording material is substantially ruled out. A desirably high optical density, good running capacity in the thermal printer, especially without depositing on or adhesion to the thermoprint in the case of application, and a homogeneous or uniform appearance of the thermal printout are to become possible. It should be possible to produce the recording material economically. Especially, the possibility should exist of simultaneous formation of the interlayers on both sides and/or the thermoreactive layers at a high coating speed.

According to the invention, this aim is addressed by a heat-sensitive recording material of the construction described at the outset, in that the hollow-sphere pigments are present as a composite pigment, with nanoscale pigment particles adhering to the surface of an organic hollow-sphere pigment.

The core idea of the invention is the particular configuration of the interlayer between the thermoreactive layer and sheet-like carrier, at least one interlayer containing composite pigments of the type described in a suitable binder, in other words this is a composite pigment, the core of which is an organic hollow-sphere pigment, with nanoscale pigment particles adhering to the surface thereof.

The binder of the interlayer is preferably present in the form of a synthetic and/or natural polymer. The invention is substantially unrestricted with regard to the selection here, as long as the desired thermoreaction is not impaired. A binder is preferred in the form of water-soluble starches, starch derivatives, hydroxyethyl celluloses, polyvinyl alcohols, modified polyvinyl alcohols, acrylamide-(meth)acrylate copolymers and/or acrylamide-acrylate-methacrylate terpolymers. Materials of this type lead to a coating which is water-soluble. On the other hand, apart from materials of this type, there are also those of the type which lead to a water-insoluble structure on formation of the interlayers. These are, for example, latices, such as polyacrylate esters, styrene-acrylate ester copolymers, styrene-butadiene copolymers, polyurethanes, acrylate-butadiene copolymers, polyvinyl acetates and/or acrylonitrile-butadiene copolymers and the like. The binder is used, especially, to advantageously connect the interlayers to the sheet-like carrier, but also to ensure an optimal binding to the subsequent layer. It is a matter for expert consideration whether to use, in the individual case, an especially suitable binder or a binder mixture here.

The organic hollow-sphere pigments representing the core of the composite pigments used according to the invention are known in the prior art. Hitherto unknown are those organic hollow-sphere pigments, on the surface of which nanoscale pigment particles adhere, such as are used in the course of the invention as “composite pigments”. During the formation of the interlayers of the recording material according to the invention, aqueous dispersions of the composite pigment can be used after the inclusion of suitable binders. In the course of the method for producing the recording material, in which drying processes are run, the aqueous portion of the dispersion of the composite pigments is evaporated with the result that the aqueous phase located within the hollow spheres of the composite pigments evaporates so that air-filled hollow-spheres remain in the composite pigment. The composite pigment preferably has a spherical equivalent diameter of about 1 to 10 μm, especially from about 1.5 to 2.5 μm. The hollow spheres contained therein preferably have a spherical equivalent diameter of about 0.7 to 5 μm, especially about 0.8 to 1.5 μm. It is especially advantageous if the organic hollow-sphere pigments have a cavity volume of about 20 to 70%, especially from about 20 to 55%. The wall material of the organic hollow-sphere pigments is formed in such a way, that, on the one hand, it has the required strength and, on the other hand, it allows the discharge of the aqueous phase originally contained therein, which is achieved by adequate porosity. The production of organic hollow-sphere pigments of this type is common in the prior art. Accordingly, the wall material thereof generally comprises of organic polymers, especially based on styrene-acrylic resins. Other wall materials can also be used, which lies within the sphere of expert action, if the desirable thermoreaction is not impaired. In the course of the invention, pure organic hollow-sphere pigments, which are known in the prior art, are accordingly not used, but organic hollow-sphere pigments, which are surface-modified.

A person skilled in the art does not have any problems in producing the composite pigment used according to the invention with the aid of the organic hollow-sphere pigments of the prior art in order to satisfy the requirements of the present invention. Thus, it is possible, for example, to slightly heat the hollow-sphere pigments used so that their surface softens to a certain extent, and to then make the nanoscale pigment particles adhere thereto in a mixing process. The organic hollow-sphere pigments may also be applied in aqueous media to the surface of the organic hollow-sphere pigments. This may take place by the inclusion of a suitable adhesive. The person skilled in the art is also not subject to any substantial restriction in the selection of the adhesive. This is, especially, a copolymer, which originates from the reaction of one or more dicarboxylic acids as a monomer and one or more monomers in the form of diamine, triamine, dialkanolamine and/or trialkanolamine. Among these amines, the diamine monomer in the form of diethanolamine and/or triethanolamine is preferred. Basically, a copolymer based on a polyamide is especially advantageous, with this originating from saturated or unsaturated, branched or unbranched C₂-C₁₀-dicarboxylic acids, especially in the form of adipic acid and the designated amine. The entire production of the composite pigment preferably takes place in an aqueous dispersion, included in conventional homogenisation measures. A grinding process can also be carried out, in which it is recommended to use dispersing or grinding auxiliary agents. The binder already mentioned is moreover introduced into the aqueous dispersion applied last. The aqueous application dispersion to form the interlayers may, however, contain further additives in order to optimise them.

The possibility also exists of providing the surfaces of the organic hollow-sphere pigments with functional groups. These may, for example, be carboxylate groups. The functional groups, by means of a chemical binding with the respective specially selected nanoscale pigment particles, lead to these adhering sufficiently firmly to the surface of the organic hollow-sphere pigments. The finally obtained composite pigment is not critically restricted with respect to its diameter. It has been shown that the composite pigment preferably has a spherical equivalent diameter of about 1 to 10 μm, especially from 1.5 to 2.5 μm.

With regard to the nanoscale pigment particles, with the aid of which the known organic hollow-sphere pigments are surface-modified and optimised with respect to the surface properties, the following is to be stated: these are especially alkaline earth carbonates, especially calcium and/or magnesium carbonate, dolomite, crystalline and/or amorphous aluminium hydroxide, synthetic and/or natural field silicates, calcium and/or magnesium sulphate, titanium dioxide, calcined clays, clays, talc, mica, zinc oxide, transparent iron pigments, dyeing pigments, synthetic pigments based on polystyrene and/or based on urea-formaldehyde resins. In this case, it is especially preferred for the calcium carbonate to be present in the form of precipitated and/or natural calcium carbonate, especially with a calcitic, vateritic or aragonitic crystal structure, and/or in the form of ground natural calcium carbonate. With respect to the spherical equivalent diameter of the nanoscale pigment particles, the invention is not subject to any critical restriction. It is preferred if the spherical equivalent diameter thereof is about 20 to 500 nm, in particular about 150 to 300 nm.

The following should additionally be stated regarding the term “composite pigment” in the form of surface-modified organic hollow-sphere pigments: when “hollow-spheres” are mentioned here, this should be understood in a broad sense. On the one hand these expressly include round or spherical structures and, on the other hand, also hollow-spherical types of particles, such as those which have a hollow hemispherical structure. It is decisive for the aimed for purposes that the “hollow spheres” or corresponding structures in the heat-sensitive recording material especially allow the desirable insulating capacity because of the air inclusions and in addition bring about the further modifying properties by the application of nanoscale particles to the surface thereof. Accordingly, positively acting surface properties are adjusted by this.

It has been shown that the incorporation of the designated composite pigments leads to an optimal solution of the aim posed, as described above. It is surprising that they are not impaired with respect to their action during the entire production process with the marked effect of shear forces, even during the application advantageously used here by means of a film press. Surprisingly, the smoothness of the interlayers achieved here is high even without the aid of additional smoothing measures and this has an advantageous effect on the quality of the print image.

It is preferred if the two interlayers of the heat-sensitive recording material according to the invention contain the designated composite pigments. The inclusion in terms of quantity of these pigments is not subject to any critical restriction. However, at least one of the interlayers contains the composite pigments in a quantity of 5 to 90% by weight, especially from about 80 to 50% by weight based on the dry mass of the interlayer material. It is therefore especially advantageous if the sheet-like carrier of the recording material has, on both sides, a thermoreactive layer with interlayers containing composite pigments. In addition, further additives, in particular optical brighteners, may be incorporated in the recording material according to the invention in the framework of purely expert considerations to promote properties.

In individual cases, it has proven to be expedient if at least one of the interlayers contains further pigments to control the porosity and the adsorption capacity of the interlayer. The optimisation of the porosity and of the absorption behaviour has an advantageous effect on the quality of the print image and on the running capacity in the thermal printer. Thus, the print image is fixed in an especially advantageous manner by an optimised porosity. The further pigments, which may be contained in the interlayer, are present in the form of natural or precipitated calcium carbonate, clays or calcined clays, diatomaceous earths, aluminium oxide, aluminium hydroxide, silicic acids, magnesium silicates and/or magnesium carbonates. Organic pigments may also be possible, such as, for example, urea-formaldehyde condensates and the like. Advantageously, the further pigments are optimised with respect to the spherical equivalent diameter and adjusted to a spherical equivalent diameter of about 0.1 to 10 μm, especially from about 1 to 5 μm.

The selection of the material of the sheet-like carrier is not critical. Thus, this may be a paper carrier based on cellulose fibre, a synthetic paper carrier, the fibres of which comprise, especially, completely or partially of plastics material fibres, or else a plastics material film.

The sheet-like carrier, the interlayers and the thermoreactive layers are preferably optimised with respect to their weight per unit area. It is accordingly preferred that the sheet-like carrier has a weight per unit area of about 20 to 600 g/m², especially from about 40 to 300 g/m² and the interlayers have a weight per unit area of about 1 to 10 g/m², especially from about 2 to 6 g/m², and/or the thermoreactive layers have a weight per unit area of 1 to 8 g/m², especially about 2 to 6 g/m². The weight per unit area of the heat-sensitive recording material according to the invention is preferably between about 30 and 650 g/m², especially between about 40 and 100 g/m² to satisfy the practical requirements.

It is possible, in the framework of the invention, to provide further layers. Thus, this may be an outer layer, which has the function of a protective layer. A layer of this type advantageously comprises film-forming polymers, such as polyvinyl alcohols, modified polyvinyl alcohols, polyacrylates and polyurethanes, into which pigments are also introduced, it being expedient to crosslink the film-forming polymer. The function of the protective layer is maintained especially favourably if the film-forming polymer is substantially cross-linked. The cross-linking generally takes place by incorporating means favouring the cross-linking during drying of the coating slip used during the formation of the protective layer.

In the selection of the colour former and the colour developer for the thermoreactive layers of the recording material according to the invention, there is no relevant restriction. In this case, colour formers will preferably be present in the form of 2-anilino-3-methyl-6-diethyl-amino-fluoran, 2-anilino-3-methyl-6-di-n-butylamino-fluoran, 2-anilino-3-methyl-6-(N-ethyl-,N-p-toluidino-amino)-fluoran, 2-anilino-3-methyl-6-(N-methyl-,N-propyl-amino)-fluoran, and/or 3.3-bis-(4-dimethylaminophenyl)-6-dimethyl-amino-phthalide, and the colour developers in the form of phenol derivatives such as 2.2-bis-(4-hydroxyphenyl)-propane, bis-(4-hydroxyphenyl)-sulphone, 4-hydroxy-4′-iso-propoxy-diphenyl-sulphone, bis-(3-allyl-4-hydroxy-phenyl)-sulphone, 2.2-bis-(4-hydroxyphenyl)-4-methyl-pentane, N-(benzenesulphonyl)-N′-(3-p-toluenesulphonyl-oxy-phenyl)-urea, zinc salts of derivatives of salicylic acid, and the binders in the form of water-soluble starches, starch derivatives, hydroxyethyl celluloses, polyvinyl alcohols, acrylamide-(meth)acrylate copolymers, acrylamide-acrylate-methacrylate terpolymers and/or latices, such as polyacrylates, poly(meth)acrylic acid esters, styrene-butadiene copolymers, polyurethanes, acrylate-butadiene copolymers. Various other substances or auxiliary agents promoting the property may also be contained in the thermoreactive layer. These may, for example, be sensitising melt auxiliary agents, lubricants, rheological auxiliary agents, fluorescent substances and the like.

The sensitising melt auxiliary agents are present, for example, in the form of 2-benzyloxy-naphthalene (BON), p-benzylbiphenyl (PBBP), oxalic acid dibenzyl ester, oxalic acid-di-(p-methylbenzyl)-ester, 1.2-bis-(phenoxy-methyl)-benzene, 4-(4-tolyloxy)-biphenyl, ethyleneglycol-diphenylether, ethyleneglycol-m-tolylether and 1.2-bis-(3.4-dimethylphenyl)-ethane and the lubricants in the form of fatty acid amides, such as, for example, stearic acid amide, fatty acid alkanolamides, such as, for example, stearic acid-methylolamide, ethylene-bis-alkanolamides, such as, for example, ethylene-bis-stearoylamide, synthetic waxes, such as, for example, paraffin waxes of various melting points, ester waxes with different molecular weights, ethylene waxes, propylene waxes with different hardnesses or else natural waxes, such as, for example, carnauba wax and/or fatty acid metallic soaps, such as, for example, zinc stearate, calcium stearate or else behenate salts, the Theological auxiliary agents in the form of water-soluble hydrocolloids, such as, for example, starches, starch derivatives, sodium alginates, polyvinyl alcohols, methyl celluloses, hydroxyethyl or hydroxypropyl methyl celluloses, carboxymethyl celluloses, poly(meth)-acrylates, the optical brighteners in the form of white toners, for example from the substance groups diaminostilbene-disulphonic acid, distyryl-biphenyles, benzoxazole derivatives, the fluorescent substances in the form of daylight luminescent pigments with different colour tones or fluorescent fibres, the ageing protection agents in the form of sterically hindered phenols, such as, for example, 1.1.3-tris-(2-methyl-4-hydroxy-5-cyclohexyl-phenyl)-butane, 1.1.3-tris-(2-methyl4-hydroxy-5-tert.-butylphenyl)-butane, 1.1′-bis-(2-methyl4-hydroxy-5-tert.-butyl-phenyl)-butane and 1.1′-bis-(4-hydroxyphenyl)-cyclohexane.

In principle, with the formation of the heat-sensitive recording material according to the invention, which was shown above, a functional material is present. In individual cases it is expedient to form further layers on-line or off-line on the thermoreactive layer as a protective layer and/or as a layer promoting the printability.

Diverse methods are available to the person skilled in the art to produce the heat-sensitive recording material according to the invention. Thus, for example, both sides of the carrier substrate can be simultaneously provided on-line in the paper machine with the coating slip to form the interlayers. It is also possible to firstly provide one and then the other side of the carrier substrate with interlayers. The respective application process is thus not subject to any restrictions and can be carried out in the conventional manner. The same also applies to the formation of the thermoreactive layer, in which an aqueous dispersion, which contains the necessary and promoting components, is applied and dried in the conventional manner. Accordingly, the person skilled in the art does not need any further technical instructions.

The advantages that are connected with the present invention can be substantially summarised as follows: the two thermoreactive layers are insulated in an excellent manner during the thermoprinting process. This leads to qualitatively high-grade prints. This is achieved with a small weight per unit area of the interlayers. The interlayers substantially promote the opacity of the recording material, so the phenomenon of text showing through on the two sides of the recording material is reduced or substantially ruled out. The recording material is economically and technically easy to produce. This may take place at high coating speeds, and this applies to all the layers. Moreover, the chemical modification of the surface of the organic hollow-sphere pigments with nanoscale particles leads to a porous structure of the interlayer and thereby promotes the adsorption of the melts forming in the application in the thermal layer, thus achieving an optimal running capacity in the thermal printer, especially without depositions or adhesion to the thermal printing head, as well as a homogeneous appearance of the thermal print. The edge sharpness of the printout and the mechanical readability of a barcode are improved. Furthermore, the dissipation of the heat energy from the thermal layer is prevented owing to the high thermal insulation effect of the composite pigments from the interlayer used according to the invention, so a recording material with a high dynamic sensitivity is achieved.

Finally, reference is to be made to an important advantage which is produced relative to a pure mixture of organic hollow-sphere pigments and nanoscale particles. The nanoscale particles tend to form agglomerates. This reduces the reactive surface. On the other hand, a mixture of this type during application in the form of an aqueous dispersion to a substantial extent leads to a segregation taking place during the application of the dispersion to the sheet-like carrier. The heavier inorganic particles settle downwardly, while the organic hollow-sphere pigments more or less float up. It has been shown by comparative tests, which will be dealt with below, that the composite pigments according to the invention, in view of the aimed for physical effects, exhibit a clear superiority compared to pure mixtures of this type.

The invention is to be described below in detail with the aid of non-restrictive examples. All weight details therein relate to oven-dry weight percentages.

### EXAMPLES

1. Production of Coating Slips to Form the Interlayers

TABLE I

| | Wet mass | Oven-dry |
|---|---|---|
| Formulation 1 | 100% kg | kg |
| Water | 0.21 | — |
| Dow Latex (48.5%)*¹ | 15.12 | 734 |
| Ropaque HP-1055 (26.5%)*² | 75.22 | 19.93 |
| PVA low viscosity, highly saponified (20%) | 8.95 | 1.79 |
| Leukophor UO (31.3%)*³ | 0.27 | 0.08 |
| Rheological auxiliary agents (25%)*⁴ | 0.23 | 0.06 |
| Application mass | 100 | 29.2 |

Comments:
*¹Binder of the styrene-butadiene latex type
*²Hollow-sphere pigment Company Rohm & Haas (styrene-acrylate polymer) Mean diameter: about 1 μm, wall diameter: about 0.1 μm
*³Optical brightener (anionic stilbene derivative) (Company Clariant)
*⁴Sterocoll type (Company BASF) (copolymer of acrylic acid esters and carboxylic acids)
pH: 7.7; Brookfield viscosity (100 rpm, spindle 3, 20° C.): 550 mPas; application: about 3 g/m²

TABLE II

| | Wet mass | Oven-dry |
|---|---|---|
| Formulation 2 | 100% kg | kg |
| Water | 1.88 | — |
| Dow Latex (48.5%)*¹ | 5.03 | 2.44 |
| VP composite*² | 83.99 | 29.4 |
| PVA low viscosity, highly saponified (20%) | 8.62 | 1.72 |
| Leukophor UO (31.3%)*³ | 0.31 | 0.1 |
| Rheological auxiliary agent (25%)*⁴ | 0.17 | 0.04 |
| Application mass | 100 | 33.7 |

Comments:
*¹Binder of the styrene-butadiene latex type
*²Composite pigment from Ropaque HP-1055 and nanoscale calcium carbonate (75%:25% oven-dry) Company Omya AG
*³Optical brightener (anionic stilbene derivative) (Company Clariant)
*⁴Sterocoll type (Company BASF) (copolymer of acrylic acid esters and carboxylic acids)
pH: 8.2; Brookfield viscosity (100 rpm, spindle 3, 20° C.): 400 mPas; Application: about 3 g/m²

TABLE III

| | Wet mass | Oven-dry |
|---|---|---|
| Formulation 3 | 100% kg | kg |
| Water | 1.88 | — |
| Dow Latex (48.5%)*¹ | 5.03 | 2.44 |
| Mixture Ropaque HP-1055 and calcium | 83.99 | 29.4 |
| carbonate*² | | |
| PVA low viscosity, highly saponified (20%) | 8.62 | 1.72 |
| Leukophor UO (31.3%)*³ | 0.31 | 0.1 |
| Rheological auxiliary agent (25%)*⁴ | 0.17 | 0.04 |
| Application mass | 100 | 33.7 |

Comments:
*¹Binder of the styrene-butadiene latex type
*²Physical mixture of Ropaque HP-1055 and nanoscale calcium carbonate (75%:25% oven-dry) Company Omya AG
*³Optical brightener (anionic stilbene derivative) (Company Clariant)
*⁴Sterocoll type (Company BASF) (copolymer of acrylic acid esters and carboxylic acids)
pH: 8.4; Brookfield viscosity (100 rpm, spindle 3, 20° C.): 400 mPas; Application: about 6 g/m²

Formulation 4:

Similar to formulation 2, but with about 5 g/m² application

Formulation 5:

Similar to formulation 2, but with about 7 g/m² application

2. Formation of the Interlayer

An application suspension to form the interlayer of a thermal paper was applied on one side on-line in the paper machine by means of a film press at an operating speed of 1,000 m/min on a paper web with a weight per unit area of 65 g/m². After the application of the aqueous application suspension, the drying process of the coated paper carrier took place in the conventional manner.

3. Production of the Coating Slip to Form the Heat-Sensitive Layer

A coating dispersion A is produced by grinding 25 parts by weight of 2-anilino-3-methyl-6-(N-ethyl-,N-isopentyl-amino)-fluoran with 45 parts by weight of a 15% aqueous polyvinyl alcohol solution in a ball mill to form a mean particle size of 1.5 μm.

A coating dispersion B is produced by grinding 50 parts by weight of 2,2-bis-(4-hydroxyphenyl)propane together with 35 parts by weight benzyl-naphthyl-ether, 90 parts by weight of a 15% aqueous polyvinyl alcohol solution and 24 parts by weight water in a mill to a mean particle size of 1.5 μm.

A heat-sensitive coating dispersion was produced using the dispersions A and B according to the following formulation.

TABLE IV

| | Dry mass | Oven-dry |
|---|---|---|
| | 100% kg | kg |
| PVA highly viscous, highly saponified (10%) | 32.3 | 3.23 |
| Leukophor UO (31.3%)*¹ | 0.77 | 0.24 |
| PCC-slurry (55%)*² | 18.25 | 10.04 |
| Dispersion B | 21.64 | 10.71 |
| Stearic acid amide dispersion*³ | 12.92 | 3.23 |
| Zn stearate dispersion*³ | 5.65 | 1.13 |
| Dispersion A | 7.66 | 3.45 |
| Rheological auxiliary agent (25%)*⁴ | 0.65 | 0.16 |
| Water | 0.16 | — |

Comments:
*¹Optical brightener (anionic stilbene derivative) (Company Clariant)
*²d₅₀: 1.0μ, calcite type,
*³Company Chukyo
*⁴Sterocoll type (Company BASF) (copolymer of acrylic acid esters and carboxylic acids)
Dry content about 32.2% by weight; pH 8.6; Brookfield viscosity (100 rpm, spindle 3, 20° C.): 420 mPas; surface tension (static ring method according to Du Noüy) 47 mN/m.

4. Formation of a Heat-Sensitive Layer

The heat-sensitive coating suspension obtained in this manner was used to produce a heat-sensitive recording material in the form of a thermal paper. The application took place with about 5.0 g/m² (oven-dried) with the aid of a curtain coating unit arranged in-line. The application speed was 1,200 m/Min. After the application of the aqueous application dispersion, the drying process of the coated paper carrier took place in the conventional manner.

By coating base paper with the interlayer application dispersions according to formulation 1 to 5 and subsequent application of the heat-sensitive layer, the thermal papers of example 1 to 5 from Table I are obtained. Prior to printing, all the papers were brought to comparable smoothness (350±30 Bekks).

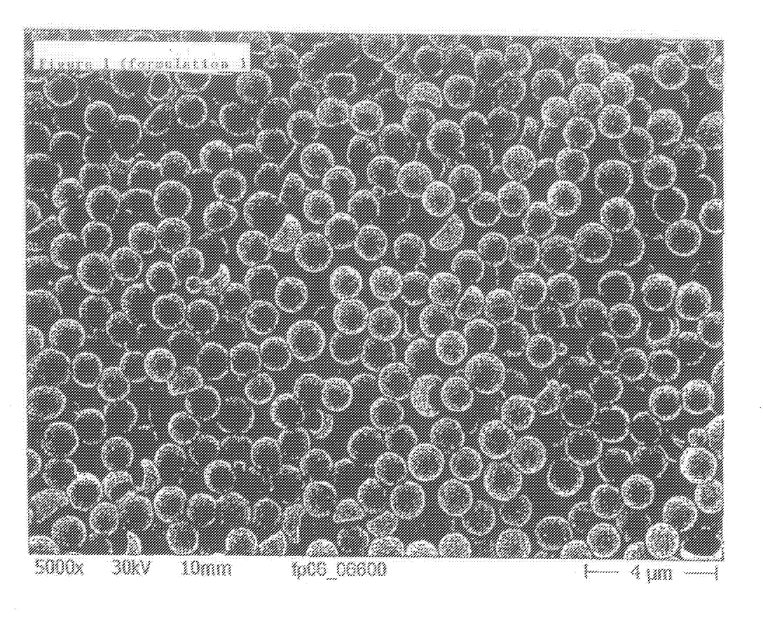

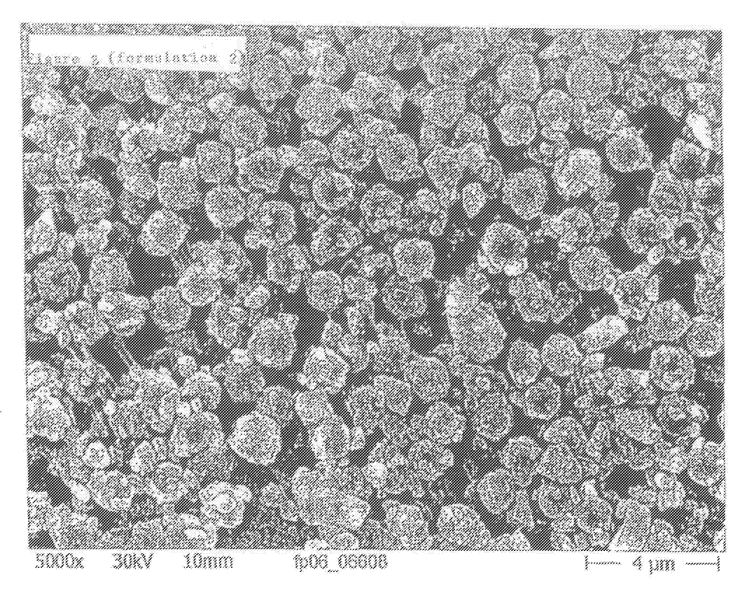

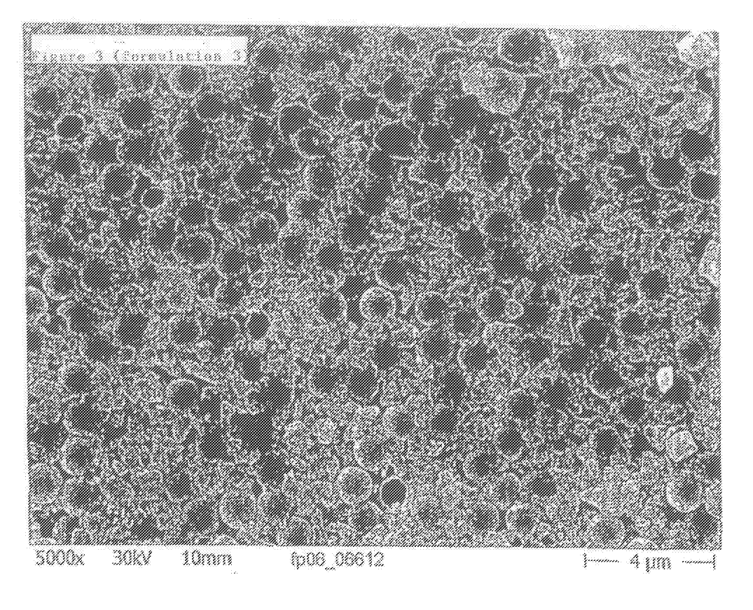

Scanning electron microscope micrographs of the paper surface before coating with the heat-sensitive layer make clear the different surface composition of the interlayers of Formulation 1 (FIG. 1), Formulation 2 (FIG. 2) and Formulation 3 (FIG. 3).

5. The efficiency of the precoats was assessed using the technical application tests on the heat-sensitive recording material (Table V):
1. Dynamic sensitivity
2. Barcode readability
3. Depositing on the thermal strip

The thermal printouts were generated using an Atlantek Thermo test printer Model 200 (Company Atlantek USA). In this case a Kyocera thermal head of 200 dpi was used.

Dynamic sensitivity: The dynamic image density (optical density) was measured using a Gretag Macbeth Densitometer Type D19C on a chessboard pattern generated with the Atlantek test printer at 0.25 mJ/dot and 0.50 mJ/dot.

Barcode readability: A barcode pattem printout (Code UPC-A and Code 39) was generated at an energy of 0.60 mJ/dot on the Atlantek test printer.

The evaluation took place with the barcode test apparatus REA PC-Scan (REA Elektronik Deutschland) to ISO 15416. The laser scanner operates at a wavelength of 670 nm. The evaluation took place using the scan reflexion profile class (decreasing quality of the barcode): A(4), B(3), C(2), D(1), E(0).

Depositing on the thermal strip: 5 m thermal papers were printed continuously with a chessboard pattern using the producer adjustments with two conventional commercial thermal printers: Epson TM-T88 II (Printer A) and Mettler LP (Printer B). The thermal strip was visually evaluated for deposits and soiling; 0=none, 1=recognisable/slight, 2=average, 3=strong/unacceptable.

TABLE V

| | Optical | | Depositing | | |
|---|---|---|---|---|---|
| | density | | thermal | | Reflexion |
| | 0.25 | 0.50 | strip | | profile |
| Pattern | mJ/dot | mJ/dot | A | B | class* |
| Example 1 | 1.23 | 1.36 | 1-2 | 2 | D(1), E(0), D(1) |
| Example 2 | 1.26 | 1.40 | 0 | 0-1 | C(2), D(1), C(2) |
| Example 3 | 1.25 | 1.36 | 1-2 | 2 | D(1), E(0), D(1) |
| Example 4 | 1.30 | 1.41 | 0 | 0-1 | C(2), D(1), B(3) |
| Example 5 | 1.29 | 1.43 | 0 | 0-1 | C(2), D(1), B(3) |

Comment:
*Evaluation of three different barcodes: longitudinal - transverse - longitudinal

1. A heat-sensitive recording material comprising a sheet-like carrier, a thermoreactive layer on at least one side of the sheet-like carrier and an interlayer which is formed between the sheet-like carrier and the respective thermoreactive layer and contains hollow-sphere pigments embedded in a binder, as well as, if appropriate, comprising further layers and/or top layers, characterised in that the hollow-sphere pigments are present as composite pigment, with nanoscale pigment particles adhering to the surface of an organic hollow-sphere pigment.

2. A recording material according to claim 1, characterised in that the nanoscale pigment particles are alkaline earth carbonates, especially calcium and/or magnesium carbonate, dolomite, crystalline and/or amorphous aluminium hydroxide, synthetic and/or natural field silicates, calcium and/or magnesium sulphate, titanium dioxide, calcined clays, clays, talc, mica, zinc oxide, synthetic pigments based on polystyrene and/or based on urea-formaldehyde resins or mixtures of said pigment particles.

3. A heat recording material according to claim 2, characterised in that the calcium carbonate is present in the form of precipitated and/or natural calcium carbonate, especially with a calcitic, vateritic or aragonitic crystal structure, and/or in the form of ground natural calcium carbonate.

4. A recording material according to claim 1, characterised in that the wall material of the organic hollow-sphere pigments is based on organic polymers, in particular on styrene/acrylic polymers and/or polystyrene.

5. A recording material according to claim 1, characterised in that the organic hollow-sphere pigments of the composite pigment have a spherical equivalent diameter of about 0.6 to 5 μm, especially from about 0.8 to 1.5 μm and the nanoscale pigment particles have a spherical equivalent diameter of about 20 to 500 nm, especially from about 150 to 300 nm.

6. A recording material according to claim 5, characterised in that the composite pigment has a spherical equivalent diameter of about 1 to 10 μm especially from about 1.5 to 2.5 μm.

7. A recording material according to claim 1, characterised in that the organic hollow-sphere pigments have a cavity volume of about 20 to 70% especially from about 20 to 55%.

8. A recording material according to claim 1, characterised in that at least one of the interlayers contains the composite pigment in a quantity of 5 to 90% by weight, especially from 50 to 80% by weight, based on dry mass.

9. A recording material according to claim 1, characterised in that the adhesion of the nanoscale pigment particles to the surface of the organic hollow-sphere pigments is brought about by an adhesive.

10. A recording material according to claim 9, characterised in that the adhesive is a copolymer which originates from the reaction of one or more dicarboxylic acids as a monomer and of one or more monomers in the form of diamines, triamines, dialkanolamines and/or trialkanolamines.

11. A recording material according to claim 10, characterised in that the copolymer is a polyamide, which originates from saturated or unsaturated, branched or unbranched C₂-C₁₀ dicarboxylic acids, especially in the form of adipic acid, and the designated amines.

12. A recording material according to claim 10, characterised in that the diamine monomer is diethanolamine and/or triethanolamine.

13. A recording material according to claim 1, characterised in that the sheet-like carrier of the recording material has, on both sides, a thermoreactive layer with interlayers containing composite pigments.

14. A recording material according to claim 1, characterised in that at least one of the interlayers contains further pigments in order to control the porosity and absorption capacity thereof.

15. A recording material according to claim 14, characterised in that the further pigments are present in the form of natural and/or precipitated calcium carbonate, clays or calcined clays, diatomaceous earths, aluminium oxide, aluminium hydroxide, silicic acid, magnesium silicates and/or magnesium carbonates.

16. A recording material according to claim 14, characterised in that the further pigments have a spherical equivalent diameter of about 0.1 to 10 μm, especially from about 1 to 5 μm.

17. A recording material according to claim 1, characterised in that further additives, especially optical brighteners, are incorporated to promote properties.

18. A recording material according to claim 1, characterised in that the sheet-like carrier is a paper carrier based on cellulose fibre, a synthetic paper carrier, the fibres of which comprise completely or partially of plastics material fibres, or a plastics material film.

19. A recording material according to claim 1, characterised in that the sheet-like carrier has a weight per unit area of about 20 to 600 g/m², especially from about 40 to 300 g/m², the respective interlayer(s) have a weight per unit area of about 1 to 12 g/m², especially from about 2 to 7 g/m² and/or the thermoreactive layer(s) have a weight per unit area of 1 to 8 g/m², especially about 2 to 6 g/m².

20. A recording material according to claim 1, characterised in that it has, as the top layer, a protective layer of film-forming polymers, which contain pigments, especially.

21. A recording material according to claim 20, characterised in that the film-forming polymer is cross-linked.

22. A recording material according to claim 1, characterised in that the weight per unit area of the recording material is between about 30 and 650 g/m², especially between about 40 and 100 g/m².

23. A recording material according to claim 9, characterised in that about 0.25 to 9% by weight, especially about 0.5 to 6.5% by weight of adhesive, are allotted to 1 part by weight dry weight of the composite pigment.

24. A recording material according to claim 1, characterised in that the binder of the respective interlayer is a synthetic and/or natural polymer.

25. A recording material according to claim 24, characterised in that the binder is present in the form of water-soluble starches, starch derivatives, hydroxyethyl celluloses, polyvinyl alcohols, modified polyvinyl alcohols, acrylamide-(meth-)acrylate copolymers and/or latices, such as especially polyacrylates, styrene-butadiene copolymers, polyurethanes, acrylate-butadiene copolymers, polyvinyl acetates and/or acrylonitrile-butadiene copolymers.
